(19) United States
(12) Patent Application Publication
(10) Pub. No.: US 2006/0155665 A1
(43) Pub. Date: Jul. 13, 2006

(54) Agent apparatus for vehicle, agent system, agent controlling method, terminal apparatus and information providing method

(75) Inventor: Hiroaki Sekiyama, Tokyo-to (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 11/320,963

(22) Filed: Dec. 30, 2005

(30) Foreign Application Priority Data
Jan. 11, 2005 (JP) 2005-004363

(51) Int. Cl. G06N 7/00

(52) U.S. Cl. 706/59

(57) ABSTRACT

An observing part observes a driving situation based on sensor information; a learning part learns by storing an observation result obtained from the observing part together with the sensor information; a determining part determining a communication action with a user based on a learning result obtained from the learning part; a display control part displaying a first image in the vehicle expressing the communication action determined by the determining part; and an obtaining part obtaining acquired information acquired from the outside of the vehicle and stored in a portable terminal apparatus. The determining part determines the communication action by reflecting the acquired information on the learning result.

### BACKGROUND OF THE INVENTION

1. Field of the Invention

The present invention relates to an agent apparatus for a vehicle, an agent controlling method, a terminal apparatus and an information providing method, and in further details, to an agent apparatus for a vehicle, an agent controlling method, a terminal apparatus and an information providing method, for executing a communication function with a personified agent.

2. Description of the Related Art

An agent apparatus is known (for example, see Japanese Laid-open Patent Application No. 2000-20888) in which images of a plurality of personified agents are provided so that the plurality of agents having different appearances may appear, and a user may freely give names for the agents having the respective appearances. In such an agent apparatus, when the user calls a name different from that of a current agent, a corresponding agent is called for, and the thus-called agent then takes over processing of the current agent.

### SUMMARY OF THE INVENTION

A so-called ‘agent’ is one which is expected to learn various sorts of information for a user, i.e., characters, actions, tastes/ideas and so forth concerning the user, for recommending appropriate information for the user.

However, in the agent apparatus in the related art, what is available to be learned by the agent is limited to those within the vehicle, and thus, occasions for learning information for the user are limited. In such a system, the agent may not always recommend appropriate information accordingly. This is because, a ratio of a time for which the user rides on the vehicle is very short in the life scenes of the user, and the agent may not necessarily learn sufficient information within such a short time for recommending appropriate information.

The present invention has been devised in consideration of such a situation, and an object of the present invention is to provide an agent system/apparatus by which appropriate information can be recommended to the user.

In one aspect of the present invention, an agent apparatus for a vehicle is provided in which,

an observing part observing a driving situation based on sensor information;

a learning part learning by storing an observation result obtained from the observing part together with the sensor information;

a determining part determining a communication action for a user based on a learning result obtained from the learning part;

a display control part displaying a first image in the vehicle carrying out the communication action determined by the determining part; and

an obtaining part obtaining acquired information acquired from the outside of the vehicle and stored in a portable terminal apparatus, are provided, and,

the determining part determines the communication action by reflecting the acquired information on the learning result.

In another aspect of the present invention, an agent apparatus is provided in which,

an on-vehicle apparatus and a portable terminal apparatus are provided, and,

both the apparatuses have respective communication functions with personified agents, and information acquired from the outside of the vehicle by the portable terminal apparatus is reflected on the communication function of the on-vehicle apparatus.

In these aspects of the present invention, since a user holds a portable terminal apparatus (for example, a cellular phone) not only in a vehicle but also in other scenes of his or her personal life, information for the user obtained from the outside of the vehicle can be easily reflected on information to be processed by the in-vehicle agent apparatus. As a result, the learning effect improves in comparison to a case where only information acquired within the vehicle is used for the learning. AS a result, appropriate information for the user can be recommended according to the present invention.

### BRIEF DESCRIPTION OF DRAWINGS

Other objects and further features of the present invention will become more apparent from the following detailed description when read in conjunction with the accompanying drawings:

FIG. 1 shows one example of a system configuration of an agent apparatus for a vehicle according to the present invention;

FIG. 2 shows one example of a system configuration of a part of a portable terminal apparatus corresponding to the agent apparatus shown in FIG. 1;

FIG. 3 shows a flow chart for transferring information concerning a user stored in the portable terminal apparatus shown in FIG. 2 to the vehicle;

FIG. 4 shows a flow chart for transferring an agent of the portable terminal apparatus to the vehicle;

FIG. 5 shows a flow chart for a case where a plurality of agents exist in the vehicle; and

FIGS. 6A and 6B illustrate a case where an agent of the portable terminal apparatus moves to the vehicle.

### DETAILED DESCRIPTION OF THE PREFERRED EMBODIMENT

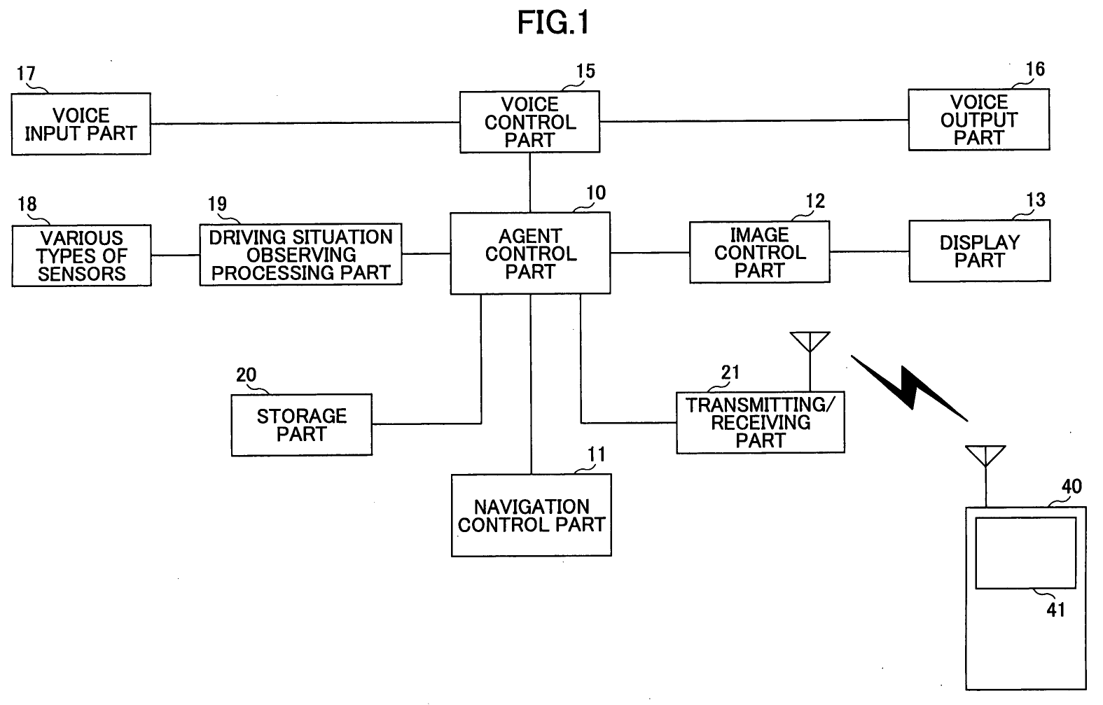

With reference to figures, the best mode for carrying out the present invention is described now. FIG. 1 shows one example of a system configuration of an agent apparatus for a vehicle according to the present invention.

As shown in FIG. 1, the agent apparatus for the vehicle includes an agent control part 10, an image control part 12, a display part 13, a voice control part 15, a voice input part 17, a voice output part 16, various types of sensors 18, a driving situation observing processing part 19, a storage part 20, a navigation control part 11 and a transmitting/receiving part 21.

The various types of sensors 18 shown in FIG. 1 denote devices for detecting vehicle situations and biological information of a user in a vehicle. The sensors for detecting vehicle situations may include, for example, an accelerator sensor, a brake sensor, a vehicle occupant sensor, a shift position sensor, a seatbelt sensor, a sensor for detecting a distance from the vehicle ahead, and so forth. Other various types of sensors for detecting vehicle situations may be provided for particular purposes. The sensors for detecting biological information of the user may include, for example, a body temperature sensor, a brain wave sensor, a heart rate sensor, a fingerprint sensor, a sight line sensor, a camera and so forth. Other various types of sensors for detecting biological information may be provided for particular purposes.

The driving situation observing processing part 19 shown in FIG. 1 observes the driving situations such as the vehicle situations and the biological information based on the sensor information detected by the above- mentioned various types of sensors 18, and transmits observation results to an agent control part 10 shown in FIG. 1.

The agent control part 10 generates and controls a personified agent which communicates with the user in the vehicle, by an information processing function of a CPU. An actual appearance of the agent may be a human being, or, other than this, it may be selected from various things, for example, an animal, a robot, a cartoon character, and so forth, according to the user's preference. The agent may be in a form of an image moving on a display device, a hologram or such. The agent control part 10 determines a communicating action of the agent for the user based on a learning result described later, and controls agent image data so that the agent may carry out the thus-determined action. The learning result is obtained as a result of the sensor information detected through the various types of sensors 18 as well as the observation result obtained by the driving situation observing processing part 19 being stored in a storage part 20 shown in FIG. 1. In a scene in which the user drives the vehicle, a location change, a time change, a traffic situation change, a vehicle occupant change, an emotion change, a psychology change, and so forth may occur. These changes are read by the various types of sensors 18, and, as a result of an answer of the user made in response to the contents recommended by the agent apparatus being learned by the agent control part 10, the contents to recommend may be changed. The agent image data may be previously stored in the storage part 20, or may be added to the storage part 20 as a result of it being downloaded from the outside of the vehicle.

The navigation control part 11 shown in FIG. 1 has a route search function, a location search function and so forth. The navigation control part 11 can recognize a position of the vehicle in a map, based on information received from a GPS (Global Positioning System) satellite through a GPS receiver (not shown) and map data in a map data database (not shown). Thereby, a route from the own vehicle position through a destination can be searched for. Further, the navigation control part 11 can search for a place which the user wishes to go, based on a facility database (not shown) storing information concerning facilities such as restaurants, parks, and so forth. These databases which the navigation control part 11 uses may be included in the vehicle itself or in a central control center located outside of the vehicle and connectable via a communication line.

The voice control part 15 shown in FIG. 1 controls a voice input part 17 also shown in FIG. 1 to transmit voice input data to the agent control part 10, or controls the voice output part 16 according to an agent voice control signal provided by the agent control part 10. The voice input part 17 includes a microphone or such taking a vehicle occupant's voice. The thus-taken voice is used, not only for verbal communication with the agent, but also identifying a person by a voice printing system. The voice output part 16 includes a speaker or such outputting a voice controlled by the voice control part 15. The voice thus output by the speaker is used for a route guidance for navigation, as a voice of the agent, or such.

The image control part 12 controls the display part 13 according to an agent display control signal provided by the agent control part 10. The display part 13 displays map information or such provided by the navigation control part 11, or the agent. The display part 13 includes a display device provided on a front console of the vehicle, or a display device provided for each seat so that the corresponding vehicle occupant may easily view.

The transmitting/receiving part 21 includes a device for providing communication with the outside of the vehicle. Thereby, data transmission/reception to/from a portable terminal apparatus 40, the central control center and so forth can be carried out.

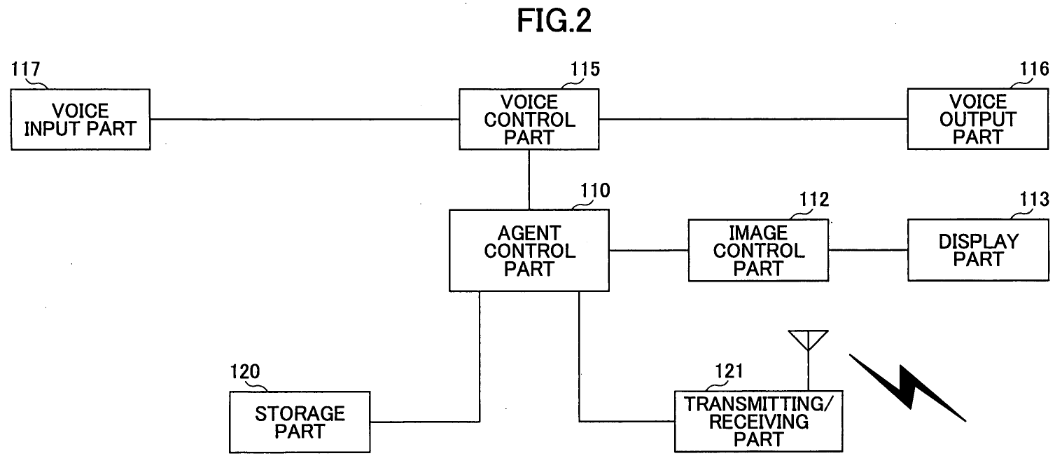

The potable terminal apparatus 40 also has a display device 41, corresponding to a display part 113 shown in FIG. 2, and, is a cellular phone, a PDA (Personal Digital Assistant) or such, which the user can carry to the outside of the vehicle. Also this portable terminal apparatus 40 provides a function of communication with a personified agent, the same as that of the above-described agent apparatus for the vehicle shown in FIG. 1.

FIG. 2 shows a block configuration of a part of the portable terminal apparatus 40 concerning the above-mentioned function. As shown in FIG. 2, the portable terminal apparatus 40 includes an agent control part 110, an image control part 112, a display part 113, a voice control part 115, a voice input part 117, a voice output part 116, a storage part 120, and a transmitting/receiving part 121.

Similar to that of the agent apparatus for the vehicle of FIG. 1, the agent control part 110 of the portable terminal apparatus 40 controls a personified agent which communicates with either the user exists inside of the vehicle or exists outside of the vehicle as long as the user holds the portable terminal apparatus 40.

The voice control part 115 of the portable terminal apparatus 40 controls the voice input part 117 to transmit voice input data to the agent control part 110, or controls the voice output part 116 according to an agent voice control signal provided by the agent control part 110. The voice input part 117 includes a microphone or such taking a vehicle occupant's voice. The thus-taken voice is used for verbal communication with the agent in the portable terminal apparatus 40. The voice output part 116 includes a speaker or such outputting a voice controlled by the voice control part 115. The voice thus output by the speaker is used as a voice of the agent in the portable terminal apparatus 40.

The image control part 112 of the portable terminal apparatus 40 controls the display part 113 according to an agent display control signal provided by the agent control part 110. The display part 113 displays the agent in the portable terminal apparatus 40.

The transmitting/receiving part 121 of the portable terminal apparatus 40 includes a device for providing communication with the above-described agent apparatus for the vehicle of FIG. 1. Thereby, data transmission/reception to/from the above-described agent apparatus for the vehicle can be carried out.

The agent in the portable terminal apparatus 40 operates on the display device 41 (display part 113) as mentioned above. In the storage part 120 of the portable terminal apparatus 40, information acquired from communication with the user is stored as acquired information. For example, when a predetermined keyword occurs in verbal communication with the user, this matter is stored there as the acquired information. Furthermore, a name of a restaurant to which the user goes, a time at which the user goes the restaurant, a positional coordinate data of the restaurant, obtained from the GPS satellite, are also stored as the acquired information. Also, information specifying an appearance of the agent in the portable terminal apparatus 40 and so forth are stored as the acquired information.

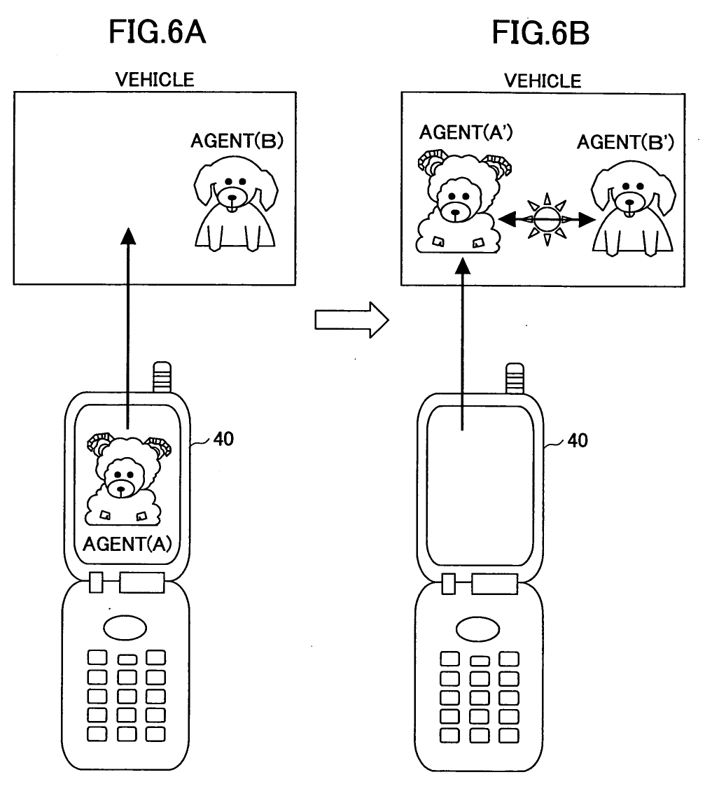

Next, cooperation between the portable terminal apparatus 40 and the vehicle in an agent system, which includes the agent apparatus for the vehicle described with reference to FIG. 1 and the part of the portable terminal apparatus 40 descried with reference to FIG. 2, is described. The portable terminal apparatus 40 is held by the user at every life scenes of the user himself or herself. Accordingly, the agent in the portable terminal apparatus 40, personified as mentioned above and operating on the display device 41 of the portable terminal apparatus 40, shares almost all of the occasions together with the user. For the purpose of executing an agent role of its own, the agent in the portable terminal apparatus 40 memories and learns predetermined keywords, a range of an action, a time of the action and so forth of the user, from communication with the user in his or her personal life. As a result, the agent in the portable terminal apparatus 40 understands the user's interests, ideas, and so forth. However, since the CPU of the portable terminal apparatus 40, not shown, which actually acts as the various control parts 110, 112 and 115 shown in FIG. 2, has a limited information processing capability, a range of the agent role which the agent in the portable terminal apparatus, which operates only within the portable terminal apparatus 40, can execute, is limited. In contrast thereto, in the vehicle which has a larger system than that of the portable terminal apparatus 40, a CPU such as a navigation ECU which acts as the navigation control part 11 of FIG. 1 has a higher information processing capability than that of the CPU of the portable terminal apparatus 40. Accordingly, as a result of the agent in the portable terminal apparatus 40 being transferred to the vehicle together with the user's interests, ideas and so forth, acquired in the portable terminal apparatus 40 as mentioned above, as well as information concerning the user acquired from communication with the user in the portable terminal apparatus 40, as shown in FIGS. 6A and 6B, the agent in the portable terminal apparatus 40 then acting as the agent in the vehicle can execute the agent role more sufficiently.

For example, a case is assumed in which the user has a lunch in an Italian restaurant before riding the vehicle. Then, in this case, after that, the user rides the vehicle, enjoys vehicle driving, and then, a time comes to have a dinner. At this time, the user asks the personified agent in the vehicle, ‘is there any place for having a nice dinner near here?’ In this case, the agent in the vehicle, which operates only within the vehicle, searches for a restaurant near here by the navigation system, and, as a result, finds out a second Italian restaurant, which is by accident located near there. Then, the agent in the vehicle replies to the user that ‘there is an Italian restaurant’. However, the agent in the portable terminal apparatus 40, which has shared the occasion with the user in the Italian restaurant for the lunch as mentioned above, can recommend rather a different genre of a restaurant from the Italian, even when the Italian restaurant has been found out as the nearest one.

Accordingly, when the agent in the vehicle can be made to understand the user's latest action details or interests/ideas by making communication with the user in his or her personal life even outside of the vehicle, the agent in the vehicle can recommend appropriate information for the user, and thus, the high-performance function in the vehicle can be effectively utilized. For this purpose, acquired information, acquired from the outside of the vehicle and stored in the storage part 120 of the portable terminal apparatus 40, should be reflected on the learning result in the agent apparatus for the vehicle of FIG. 1.

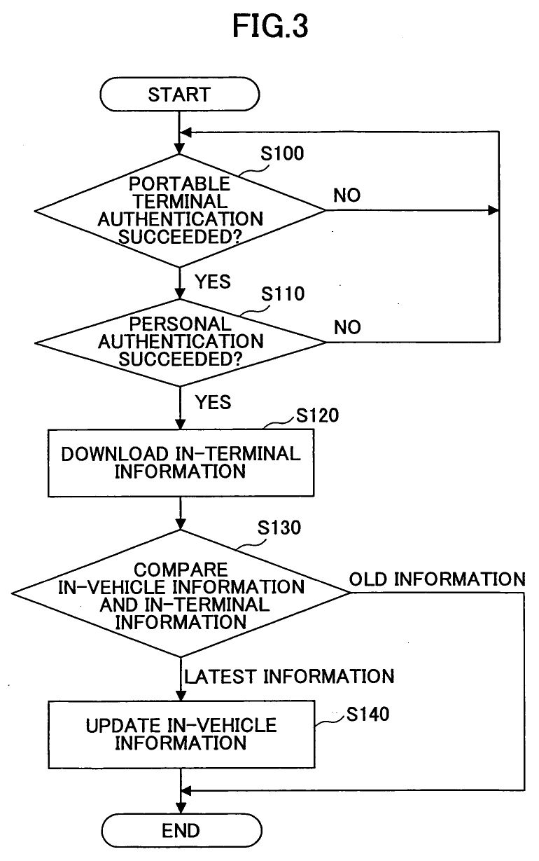

FIG. 3 shows a flow chart for transferring the acquired information concerning the user stored in the portable terminal apparatus 40 to the vehicle. The agent system in the portable terminal apparatus 40, described above with reference to FIG. 2, and the agent system in the vehicle, described above-mentioned with reference to FIG. 1, operate separately unless they are linked together. Both the agent systems should be linked together so that the information stored there respectively may be transferred mutually and linked together, and thus, the latest states should be ensured. This linkage may be always made. However, instead, the linkage may be made when the user actually uses the vehicle, and thus, the latest states should be ensured also in this case. In order to achieve an accurate linkage therebetween, a time base should be matched together. For example, the time base should be managed with the use of the Greenwich Mean Time applied by the GPS.

In Steps S100 and S110 of FIG. 3, authentication is carried out to prove that the portable terminal apparatus 40 is an authorized one and that the user is an authorized person. Unless the authentication is succeeded in, the acquired information concerning the user is not transferred from the portable terminal apparatus 40 to the vehicle. When the authentication is succeeded in each step, Step S120 is carried out. In Step S120, the acquired information concerning the user (referred to as in-terminal acquired information) is downloaded from the portable terminal apparatus 40 to the vehicle. In Step S130, when the thus-downloaded in-terminal acquired information is newer than the information already stored in the storage part 20 of the agent apparatus for the vehicle (referred to as in-vehicle stored information), the in-vehicle stored information is updated by the thus-transferred in-terminal acquired information in Step S140. On the other hand, when the thus-downloaded in-terminal acquired information is older than the in-vehicle stored information, the in-vehicle stored information is kept unchanged.

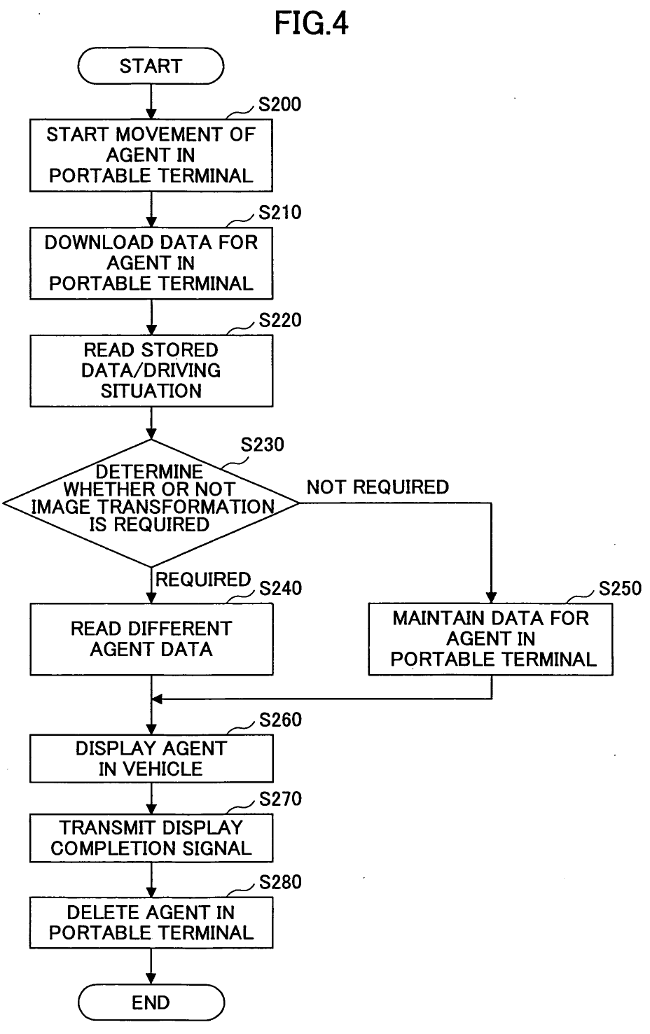

As mentioned above, the in-terminal acquired information transferred from the portable terminal apparatus 40 to the vehicle as shown in FIG. 3 may include information concerning predetermined keywords, facilities where the user went, and so forth. The information to be thus transferred also includes information for specifying an appearance of the agent in the portable terminal apparatus 40. FIG. 4 shows a flow chart for transferring, in response to the user's instruction, the agent in the portable terminal apparatus 40 to the vehicle. In Step S200, in response to the user's instruction, transfer (i.e., movement) of the agent in the portable terminal apparatus 40 (i.e., the information specifying the appearance of the agent in the portable terminal apparatus 40 and so forth) is started, and thus, the movement of the agent in the portable terminal apparatus 40 is carried out in Step S210. At this time, current driving situations are read through the various types of sensors 18, and also, the learning result is read from the storage part 20 in Step S220. Then, in Step S230, based on the information thus read from the various types of sensors 18 and the storage part 20, the agent control part 10 determines whether or not appearance transformation should be carried out (i.e., whether or not an image for an agent should be changed). When determination is made to carry out transformation, image data of a different agent is read from the storage part 20 in Step S240. On the other hand, when determination is made not to carry out transformation, the current image data of the agent in the portable terminal apparatus 40 is kept unchanged in the vehicle, in Step S250. Then, the thus-obtained agent image data according to the determination result of Step 230 is applied to display on the display part 13 an agent in the vehicle, corresponding to the agent in the portable terminal apparatus 40, the data of which has been downloaded in Step S210, in Step S260. At this time, at the same time or immediately before the agent in the vehicle is thus displayed on the display part 13, the matter of displaying the agent in the vehicle is notified of to the agent control part 110 of the portable terminal apparatus 40 in Step S270. In response to this notification, the agent control part 110 in the portable terminal apparatus 40 deletes the corresponding agent in the portable terminal apparatus 40 from the display device 41 (display part 113) in Step S280.

As a result of the notification of displaying the agent in the vehicle corresponding to the agent in the portable terminal apparatus 40 being made to the portable terminal apparatus 40 as mentioned above, whereby the corresponding agent in the portable terminal apparatus 40 is thus removed from the display device 41 of the potable terminal apparatus 40, the user is made to recognize as if the agent in the portable terminal apparatus 40 moves from the portable terminal apparatus 40 to the vehicle, for the case where the determination is made in Step S230 that the appearance of the agent in the vehicle corresponding to the agent in the portable terminal apparatus 40 is not changed. Further, as the determination is thus made as to whether or not the agent in the vehicle is transformed in Step S230, the appearance of the agent in the vehicle can be controlled to be suitable to the vehicle situation. In this connection, an in-vehicle space is rather public to some extent since the in-vehicle space may be shaped also by a person other than the driver. In contrast thereto, the portable terminal apparatus 40 which is owned by the user is very private. In this view, the appearance of the agent in the vehicle may be transformed according to TPO in the vehicle. For example, when the agent in the portable terminal apparatus 40 has an appearance of a cartoon character, the agent apparatus for the vehicle according to the present invention can transform the agent in the vehicle corresponding to the agent in the portable terminal apparatus 40 to have an appearance of a secretary for a case where the vehicle to which the user moves is a commercial vehicle owned by a company. The same processing as that described above with reference to FIGS. 3 and 4 may be carried out also for an opposite direction, i.e., for a case where information is transferred from the vehicle to the portable terminal apparatus 40.

A trigger to initiate the above-mentioned transfer of the information concerning the user or the above-mentioned transfer of the agent in the portable terminal apparatus 40 or in the vehicle may be a manual operation by the user, a matter that a predetermined requirement is met, or such. For example, the above-mentioned trigger may be a matter that the user holds the portable terminal apparatus 40 in front of the display part 13 of the vehicle, a predetermined button on the portable terminal apparatus 40 is operated by the user, the user makes corresponding instructions by his or her voice to the portable terminal apparatus 40, an ignition of the vehicle is turned on, the user's entering the vehicle is detected via an in-vehicle camera, the portable terminal apparatus 40 enters a range of the vehicle in which direct communication is available between the portable terminal apparatus 40 and the vehicle, or such. In connection with the range of the vehicle in which direct communication is available between the portable terminal apparatus 40 and the vehicle, a configuration may be made such that, in order that a person in the vehicle can recognize visually that a person who has the potable terminal apparatus 40 approaches the vehicle externally, the corresponding agent displayed on the display part 13 increases in its size as a distance to the person decreases.

A method of displaying the agent in the vehicle may be that in which, a correspondence between an ID of the portable terminal apparatus 40 and an appearance of a specific agent is previously registered in the storage part 20, and therewith, the specific agent is displayed on the display part 13 in response to instructions coming from the portable terminal apparatus 40. Instead of the ID of the portable terminal apparatus 40, a correspondence between biological authentication information identifying a person and an appearance of a specific agent may be previously registered, and therewith, the specific agent is displayed on the display part 13 in response to the registered biological information is detected.

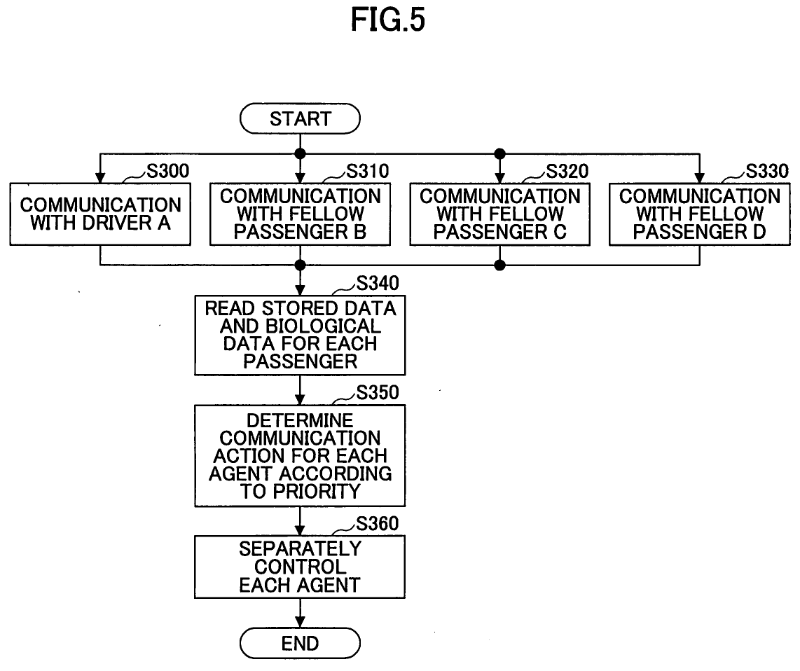

There may be a scene in the vehicle, not only one in which only a driver rides alone, but also one in which a plurality of persons ride together in the vehicle. FIG. 5 shows a flow chart for a case where a plurality of agents in the vehicle, corresponding to the respective ones of the plurality of persons, are generated in the vehicle. That is, a case is assumed in which, in the vehicle, other than a driver A, fellow passengers B, C and D sit on the seats. These respective vehicle occupants, i.e., the driver A and the follow passengers B, C and D, have their own agents. Information of the acquired information concerning these persons A, B, C and D, stored in the respective ones of their own portable terminal apparatuses 40, is transferred and is stored in the storage part 20 of the vehicle, separately for the respective users A, B, C and D, in the process described above with reference to FIGS. 3 and 4. The respective agents in the vehicle, thus transferred from the respective portable terminal apparatuses 40, are displayed on the respective display parts 13, disposed in such positions that the respective occupants may easily view the respective agents in the vehicle of there own. For example, for an occupant who sits on a rear seat of the vehicle, the display part 13 is disposed on a back surface of an immediately front seat. When the respective agents in the vehicle of these four occupants are displayed together on one display part 13, the respective agents in the vehicle may be displayed in such a manner that these are positioned in relation corresponding to an actual positional relation between the four occupants, observed with the use of an occupant detection sensor which detects an existence of the occupant by detecting a load applied to the corresponding seat, with the use of a face recognition technology with a camera, and so forth.

As shown in Steps S300 through S330 of FIG. 5, the respective occupants may have communication with their own agents in the vehicle, respectively. Information thus acquired in the communication is stored in the storage part 20 separately for the respective occupants. The agent control part 10 reads the thus-stored data and biological information (obtained by the sensors 18) of the respective occupants in Step S340, and determines respective communication actions for the respective occupants, according to a predetermined priority order in Step S350. For example, the priority order among these four persons is previously registered, and the agent control part 10 makes determination such that a communication action for a person having a higher priority is given priority. The agent control part 10 controls the respective agents in the vehicle separately in such a manner that the agents in the vehicle carry out the thus-determined communication actions, respectively, in Step S360.

The preferable embodiment of the present invention is described above. However, embodiments of the present invention are not limited thereto. Variations and modifications may be made without departing from the basic concept of the present invention claimed below.

In the above-described embodiment, information acquired from communication between the agent in the portable terminal apparatus and the user is stored. Instead of applying such an agent system, a user may input information, by himself or by herself, which he or she wishes to store in the storage part 20. Furthermore, log information, such as that automatically stored when the Internet is connected with, may be stored as the acquired information in the storage part 20.

The present application is based on Japanese priority application No. 2005-004363, field on Jan. 11, 2005, the entire contents of which are hereby incorporated herein by reference.

What is claimed is:

1. An agent apparatus for a vehicle, comprising:
an observing part observing a driving situation based on sensor information;
learning part learning by storing an observation result obtained from said observing part together with the sensor information;
a determining part determining a communication action for a user based on a learning result obtained from said learning part;
a display control part displaying a first image in the vehicle carrying out the communication action determined by said determining part; and
an obtaining part obtaining acquired information acquired from the outside of the vehicle and stored in a portable terminal apparatus, wherein:
said determining part determines the communication action by reflecting the acquired information on the learning result.

2. The agent apparatus as claimed in claim 1, wherein:
said portable terminal apparatus has a communication function with a personified second image in the portable terminal apparatus; and
said acquired information is acquired from a communication with said second image.

3. The agent apparatus as claimed in claim 1, wherein:
said acquired information comprises information concerning a place at which the user holding the portable terminal apparatus moves.

4. The agent apparatus as claimed in claim 1, wherein:
said driving situation comprises at least one of a vehicle situation and the user's biological information.

5. The agent apparatus as claimed in claim 1, wherein:
said acquired information is reflected on the learning result in response to the user's instruction information.

6. The agent apparatus as claimed in claim 5, wherein:
said instruction information comprises a predetermined input operation to said portable terminal apparatus.

7. The agent apparatus as claimed in claim 1, wherein:
said acquired information is reflected on the learning result when said portable terminal apparatus stands enters a predetermined range from said user's vehicle.

8. The agent apparatus as claimed in claim 7, wherein:
said predetermined range comprises a range in which communication is available between said portable terminal apparatus and said user's vehicle.

9. The agent apparatus as claimed in claim 1, wherein:
for a case where the plurality of first images in the vehicle are provided for respective users, said determining part determines the respective communication actions of respective ones of said plurality of first images.

10. The agent apparatus as claimed in claim 9, wherein:
said determining part determines the respective communication actions according to a priority order among the respective users.

11. The agent apparatus as claimed in claim 2, wherein:
when any one of said first image in the vehicle and said second image in the portable terminal apparatus is displayed, the other is not displayed.

12. The agent apparatus as claimed in claim 1, wherein:
said first image in the vehicle is displayed when an ignition is turned on, and is not displayed when the ignition is turned off.

13. The agent apparatus as claimed in claim 1, wherein:
said display control part displays the first image corresponding to identification information of said portable terminal apparatus.

14. The agent apparatus as claimed in claim 1, wherein:
when the first image in the vehicle is provided correspondingly to each user, said display control part displays the first image corresponding to the user.

15. The agent apparatus as claimed in claim 14, wherein:
said observing part observes positional relationship between the respective users; and
the first images corresponding to the respective users are displayed according to the observed positional relationship.

16. The agent apparatus as claimed in claim 2, wherein:
said first image in the vehicle and the second image in the portable terminal apparatus have a common appearance.

17. The agent apparatus as claimed in claim 1, wherein:
said first image in the vehicle transforms itself into another image according to the learning result.

18. The agent apparatus as claimed in claim 1, wherein:
a size of said first image in the vehicle changes according to a distance from said portable terminal apparatus.

19. An agent system comprising an on-vehicle apparatus and a portable terminal apparatus, wherein:
both the apparatuses have respective communication functions with personified agents, and information acquired from the outside of the vehicle by the portable terminal apparatus is reflected on the communication function of the on-vehicle apparatus.

20. An agent controlling method, comprising:
an observing step of observing a driving situation based on sensor information;
a learning step of learning, by storing an observation result obtained from said observing step together with the sensor information;
a determining step of determining a communication action for a user based on a learning result obtained from said learning step;
a display control step of displaying a first image in the vehicle carrying out the communication action determined by said determining step; and
an obtaining step of obtaining acquired information acquired from the outside of the vehicle and stored in a portable terminal apparatus, wherein:
in said determining step, the communication action is determined with the acquired information reflected on the learning result.

21. The agent controlling method as claimed in claim 20, wherein:
said portable terminal apparatus has a communication function with a personified second image in the portable terminal apparatus; and
said acquired information is acquired from a communication with said second image.

22. The agent controlling method as claimed in claim 20, wherein:
said acquired information comprises information concerning a place at which the user holding the portable terminal apparatus moves.

23. The agent controlling method as claimed in claim 20, wherein:
said driving situation comprises at least one of a vehicle situation and the user's biological information.

24. The agent controlling method as claimed in claim 20, wherein:
said acquired information is reflected on the learning result in response to the user's instruction information.

25. The agent controlling method as claimed in claim 24, wherein:
said instruction information comprises a predetermined input operation to said portable terminal apparatus.

26. The agent controlling method as claimed in claim 20, wherein:
said acquired information is reflected on the learning result when said portable terminal apparatus enters a predetermined range from said user's vehicle.

27. The agent controlling method as claimed in claim 26, wherein:
said predetermined range comprises a range in which communication is available between said portable terminal apparatus and said user's vehicle.

28. The agent controlling method as claimed in claim 20, wherein:
for a case where the plurality of first images in the vehicle are provided for respective users, the respective communication actions of said plurality of first images are determined in said determining step.

29. The agent controlling method as claimed in claim 28, wherein:
in said determining step, the respective communication actions are determined according to a priority order among the respective users.

30. The agent controlling method as claimed in claim 21, wherein:
when any one of said first image in the vehicle and said second image in the portable terminal apparatus is displayed, the other is not displayed.

31. The agent controlling method as claimed in claim 20, wherein:
said first image in the vehicle is displayed when an ignition is turned on, and is not displayed when the ignition is turned off.

32. The agent controlling method as claimed in claim 20, wherein:
in said display control step, the first image corresponding to identification information of said portable terminal apparatus is displayed.

33. The agent controlling method as claimed in claim 20, wherein:
when the first image in the vehicle is provided correspondingly to each user, the first image corresponding to the user is displayed in said display control step.

34. The agent controlling method as claimed in claim 33, wherein:
in said observing step, positional relationship between the respective users is observed; and
the first images corresponding to the respective users are displayed according to the observed positional relationship.

35. The agent controlling method as claimed in claim 21, wherein:
said first image in the vehicle and the second image in the portable terminal apparatus have a common appearance.

36. The agent controlling method as claimed in claim 20, wherein:
said first image in the vehicle transforms itself into another image according to the learning result.

37. The agent controlling method as claimed in claim 20, wherein:
a size of said first image in the vehicle changes according to a distance from said portable terminal apparatus.

38. An agent controlling method for an on-vehicle apparatus and a portable terminal apparatus, wherein:
both the apparatuses have respective communication functions with personified agents, and information acquired from the outside of the vehicle by the portable terminal apparatus is reflected on the communication function of the on-vehicle apparatus.

39. A terminal apparatus providing predetermined information to an agent apparatus for a vehicle, said agent apparatus comprising an observing part observing a driving situation based on sensor information; learning part learning by storing an observation result obtained from said observing part together with the sensor information; a determining part determining a communication action for a user based on a learning result obtained from said learning part; and a display control part displaying an image in the vehicle carrying out the communication action determined by said determining part, comprising:
an acquiring part acquiring predetermined information from the outside of the vehicle; and
a providing part providing the predetermined information acquired by said acquiring part to the agent apparatus for the vehicle, wherein:
said predetermined information comprises such information that the determining part of the agent apparatus for the vehicle determines the communication action by reflecting said information on the learning result.

40. An information providing method comprising:
an acquiring part of acquiring predetermined information from the outside of a vehicle; and
a step of providing the predetermined information for an agent controlling method, said agent controlling method comprising an observing step of observing a driving situation based on sensor information;
learning part step of learning by storing an observation result obtained from said observing step together with the sensor information; a determining step of determining a communication action for a user based on a learning result obtained from said learning step; and a display control step of displaying an image in the vehicle expressing the communication action determined by said determining step, wherein,
said predetermined information comprises such information that, in the determining step of the agent controlling method, the communication action is determined with said information reflected on the learning result.
